(19) United States
(12) Patent Application Publication
(10) Pub. No.: US 2016/0285898 A1
(43) Pub. Date: Sep. 29, 2016

(54) MANAGEMENT PROGRAM, MANAGEMENT APPARATUS, AND MANAGEMENT METHOD

(71) Applicant: FUJITSU LIMITED, Kawasaki-shi (JP)

(72) Inventor: Akio ISHII, Yokohama (JP)

(73) Assignee: FUJITSU LIMITED, Kawasaki-shi (JP)

(21) Appl. No.: 15/055,389

(22) Filed: Feb. 26, 2016

(30) Foreign Application Priority Data
Mar. 25, 2015 (JP) 2015-061887

(51) Int. Cl. H04L 29/06

(52) U.S. Cl. CPC H04L 63/1416; H04L 63/02

(57) ABSTRACT

A non-transitory computer-readable storage medium storing therein a management program that causes a computer to execute a process includes acquiring connection information relating to management target terminals connected to other management target terminals and accumulating the connection information in a storage, and specifying according to detection of malware that performs a harmful action in first management target terminals included in the management target terminals, on the basis of the connection information relating to the first management target terminals accumulated in the storage, a monitoring target terminal that needs to be monitored.

### CROSS-REFERENCE TO RELATED APPLICATION

This application is based upon and claims the benefit of priority of the prior Japanese Patent Application No. 2015-061887, filed on Mar. 25, 2015, the entire contents of which are incorporated herein by reference.

### FIELD

The present invention relates to a management program, a management apparatus, and a management method.

### BACKGROUND

A security administrator (hereinafter simply referred to as administrator as well) in a company or an organization performs not only detection, quarantine, and extermination of computer viruses by a virus definition file but also detection of activities by malware other than the computer viruses, prevention of spread, and the like.

Malware is a general term of malicious software including computer viruses. Specifically, the malware performs, for example, activities of infecting terminals used in a company or an organization (hereinafter referred to as management target terminals as well) and enabling unauthorized accesses and the like from the outside.

In recent years, malware has emerged that has a latency characteristic of not immediately performing activities after infecting terminals used in a company or an organization (hereinafter simply referred to as attack target). Therefore, when an administrator detects a terminal infected with the malware, the administrator needs to specify other terminals in which the malware is latent (terminals in which the malware has not started activities yet) and take measures such as extermination (see, for example, Japanese Laid-open Patent Publication No. 2006-040196 (Patent Literature 1) and Japanese Laid-open Patent Publication No. 2009-110270 (Patent Literature 2).

### SUMMARY

According to an aspect of the embodiments, a non-transitory computer-readable storage medium storing therein a management program that causes a computer to execute a process includes acquiring connection information relating to management target terminals connected to other management target terminals and accumulating the connection information in a storage, and specifying according to detection of malware that performs a harmful action in first management target terminals included in the management target terminals, on the basis of the connection information relating to the first management target terminals accumulated in the storage, a monitoring target terminal that needs to be monitored.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining the overall configuration of an information processing system 10.

FIG. 2 is a diagram for explaining specific examples of the infection of malware to the management target terminals 2.

FIG. 3 is a diagram for explaining specific examples of the infection of malware to the management target terminals 2.

FIG. 4 is a diagram for explaining specific examples of the infection of malware to the management target terminals 2.

FIG. 5 is a diagram for explaining the hardware configuration of the management apparatus 1.

FIG. 6 is a functional block diagram of the management apparatus 1 depicted in FIG. 5.

FIG. 7 is a flowchart for explaining an overview of terminal specifying processing in the first embodiment.

FIG. 8 is a flowchart for explaining an overview of terminal specifying processing in the first embodiment.

FIG. 9 is a diagram for explaining the overview of the terminal specifying processing in the first embodiment.

FIG. 10 is a diagram for explaining the overview of the terminal specifying processing in the first embodiment.

FIG. 11 is a flowchart for explaining details of the terminal specifying processing in the first embodiment.

FIG. 12 is a flowchart for explaining details of the terminal specifying processing in the first embodiment.

FIG. 13 is a flowchart for explaining details of the terminal specifying processing in the first embodiment.

FIG. 14 is a flowchart for explaining details of the terminal specifying processing in the first embodiment.

FIG. 15 is a diagram for explaining a specific example of the connection information 131 acquired from the management target terminal 2a by the management apparatus 1.

FIG. 16 is a diagram for explaining a specific example of the connection information 131 acquired from the management target terminal 2b by the management apparatus 1.

FIG. 17 is a diagram for explaining a specific example of the connection information 131 acquired from the management target terminal 2c by the management apparatus 1.

FIG. 18 is a diagram for explaining specific examples of extracted information extracted from the connection information 131 by the connection-information managing unit 112.

FIG. 19 is a diagram for explaining specific examples of extracted information extracted from the connection information 131 by the connection-information managing unit 112.

FIG. 20 is a diagram for explaining specific examples of extracted information extracted from the connection information 131 by the connection-information managing unit 112.

FIG. 21 is a diagram for explaining the specific example of the tabulated information.

FIG. 22 is a diagram for explaining the specific example of the management table.

FIG. 23 is a diagram for explaining specific examples of extracted information extracted from the connection information 131 by the connection-information managing unit 112.

FIG. 24 is a diagram for explaining specific examples of extracted information extracted from the connection information 131 by the connection-information managing unit 112.

FIG. 25 is a diagram for explaining specific examples of extracted information extracted from the connection information 131 by the connection-information managing unit 112.

FIG. 26 is a diagram for explaining a specific example of the tabulated information.

FIG. 27 is a diagram for explaining a specific example of the management table.

FIG. 28 is a diagram for explaining a specific example of the connection information 131 acquired from the management target terminal 2a by the management apparatus 1.

### DESCRIPTION OF EMBODIMENTS

When specifying the terminals in which the malware is latent, the administrator refers to information indicating other terminals accessed by the terminal which is infected with the malware and information such as user IDs and the like used in accessing the other terminals (these kinds of information are hereinafter simply referred to as logs as well).

However, a latent period of some malware exceeds half a year. Therefore, the administrator needs to store logs for a long period in order to specify the terminal in which the malware is latent.

When a terminal infected with the malware is detected, since infection spread of the malware needs to be prevented, the administrator needs to specify other terminals infected with the malware (terminals in which the malware is latent) in as short a period as possible.

However, when the stored logs are used for other than specifying the terminal infected with the malware, in specifying the other terminals infected with the malware, the administrator needs to perform conversion, analysis, and the like of the stored logs. Therefore, the administrator is sometimes unable to specify the other terminals infected with the malware and take measures for the specified terminals before the infection of the malware spreads. The first embodiment will be explained hereinbelow.

Configuration of an Information Processing System

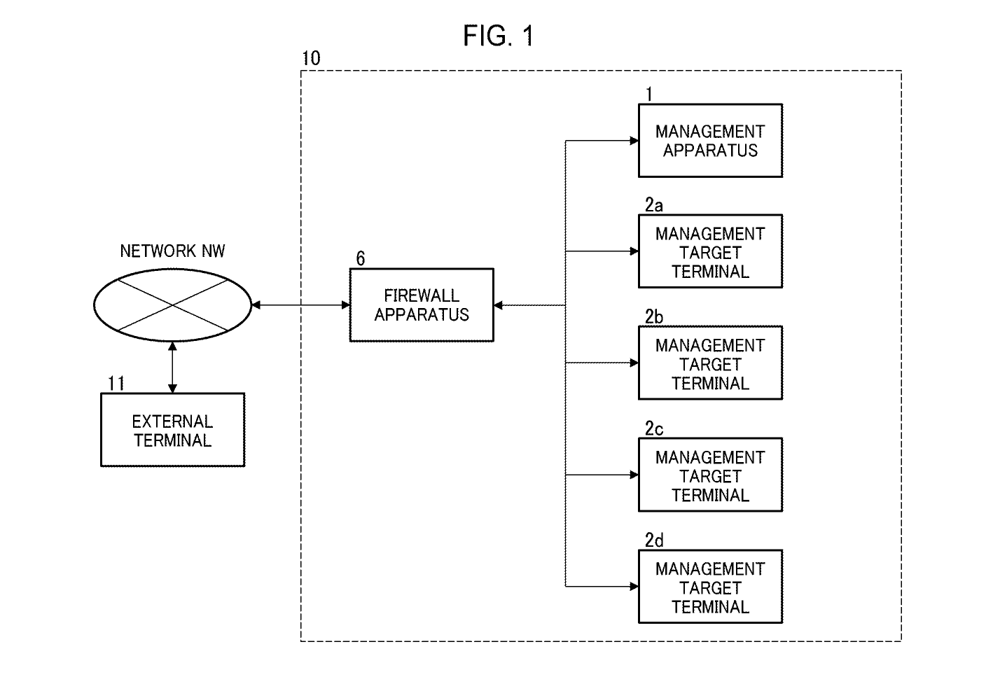

FIG. 1 is a diagram for explaining the overall configuration of an information processing system 10. The information processing system 10 depicted in FIG. 1 includes a management apparatus 1, management target terminals 2a, 2b, 2c, and 2d (these are hereinafter collectively referred to as management target terminals 2 as well), and a firewall apparatus 6.

The management apparatus 1 performs collection of logs output by the management target terminals 2. The management apparatus 1 performs management of user authorities (e.g., user IDs and passwords) of the management target terminals 2.

The management target terminals 2 are terminals used by business operators who perform jobs in a company or an organization (hereinafter simply referred to as business operators as well) and are management target terminals in which the management apparatus 1 performs, for example, detection of malware. Note that the information processing system 10 depicted in FIG. 1 includes four management target terminals 2 (management target terminals 2a, 2b, 2c, and 2d). However, the information processing system 10 may include three or less management target terminals 2 or five or more management target terminals 2.

The firewall apparatus 6 controls communication between an external terminal 11 connected to a network NW and the management apparatus 1 and the management target terminals 2. That is, the firewall apparatus 6 prevents, for example, unauthorized accesses to the management apparatus 1 and the management target terminals 2 by using the external terminal 11. Note that the network NW is, for example, the Internet.

Infection of Malware to the Management Target Terminals

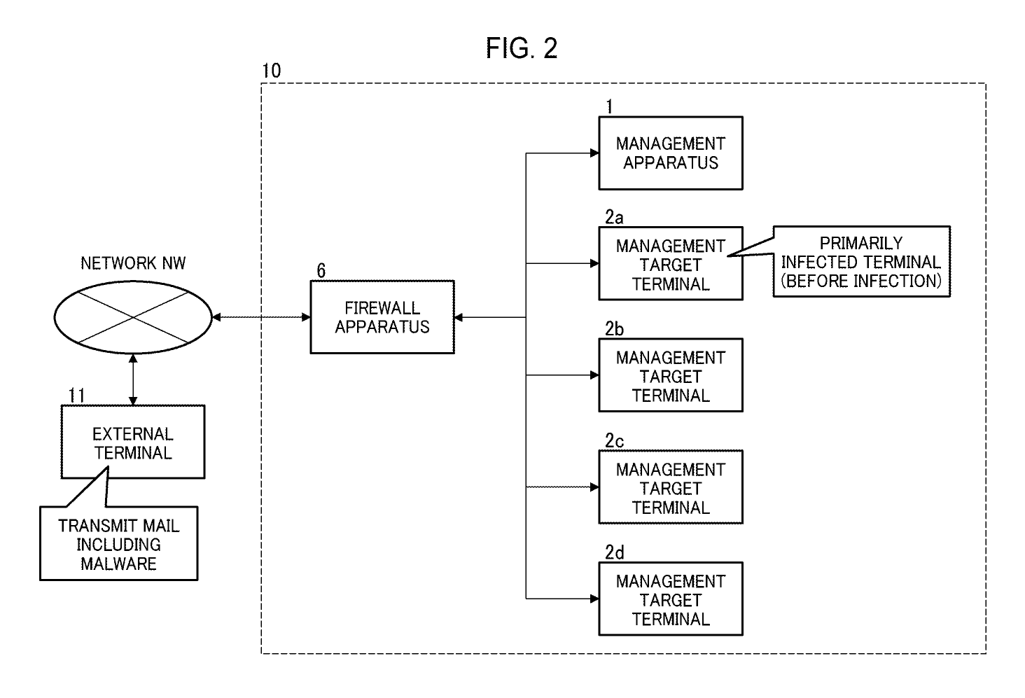

Infection of malware to the management target terminals 2 is explained. FIGS. 2 to 4 are diagrams for explaining specific examples of the infection of malware to the management target terminals 2.

In recent years, types of malware have been continuing to increase. There is also malware that seemingly has no problem such as malware included in an attachment file of a mail. Therefore, when the firewall apparatus 6 explained with reference to FIG. 1 is unable to recognize malware attached to a mail transmitted to the management target terminals 2, the firewall apparatus 6 permits transmission of the mail. In this case, when the management target terminals 2 receiving the mail open files attached to the mail, the management target terminal 2 is infected with the malware included in the file.

As the malware explained above, there is malware having a latent characteristic of not immediately performing activities after infecting the management target terminals 2. Such malware starts activities when a latent period decided in advance elapses. That is, the malware starts activities, for example, at timing when an attack target is damaged most.

Note that, in the following explanation, the malware latent in the management target terminals 2 is referred to as malware before infection as well. The malware already started activities in the management target terminals 2 is referred to as malware after infection as well. An attack targeting a specific company or organization (attack target) with the mail or the like including the malware as explained above is referred to as targeted attack. Further, the management target terminal 2 infected first in the attack target is referred to as primarily infected terminal as well. The management target terminals 2 infected with the malware through the primarily infected terminal are referred to as secondarily infected terminals as well.

In the example depicted in FIG. 2, for example, a malicious person (a person who performs an attack on the attack target) performs the targeted attack on the management target terminals 2 included in the information processing system 10 via the external terminal 11. Specifically, as depicted in FIG. 2 the external terminal 11 transmits a mail attached with a file including malware to the management target terminal 2a included in the information processing system 10. Thereafter, when a business operator who uses the management target terminal 2a opens the file attached to the mail transmitted from the external terminal 11, the management target terminal 2a is infected (primarily infected) with the malware. For example, the malware infecting the management target terminal 2a is latent until a period decided in advance elapses without starting activities in the management target terminal 2a.

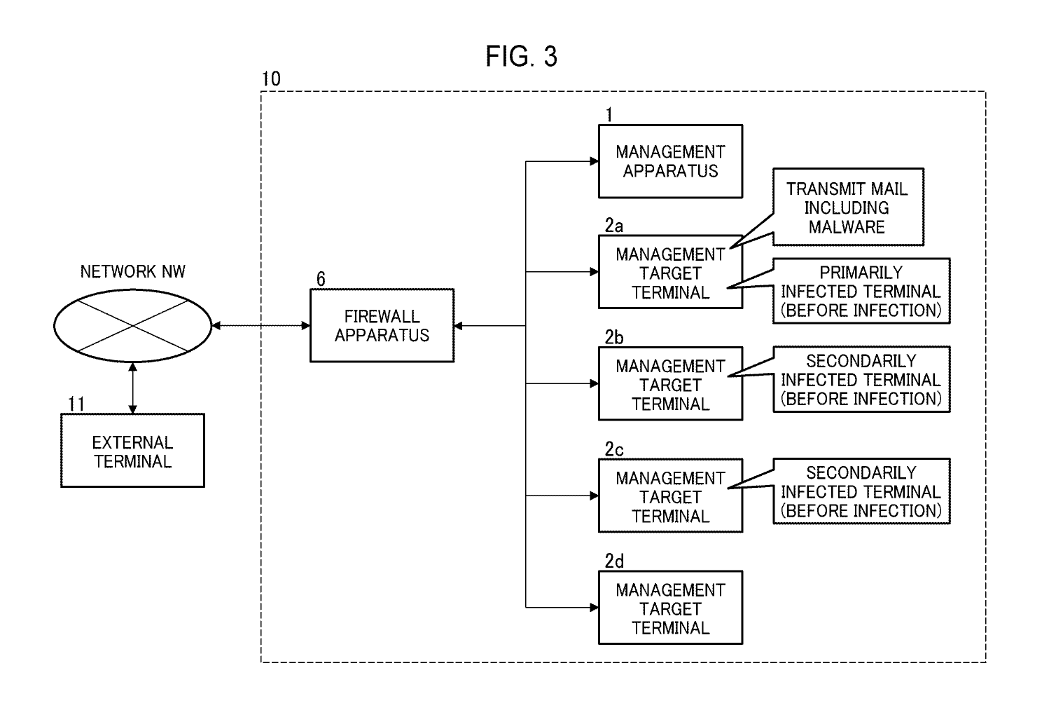

Subsequently, as depicted in FIG. 3, for example, the management target terminal 2a (the malware infecting the management target terminal 2a) transmits a mail attached with the file including the malware to the other management target terminals 2 included in the information processing system 10. When business operators who use the other management target terminals 2 open the file attached to the mail transmitted from the management target terminal 2a, the other management target terminals 2 are infected (secondarily infected) with the malware same as the malware infecting the management target terminal 2a. Note that, in the example depicted in FIG. 3, the management target terminals 2b and 2c are infected with the malware anew.

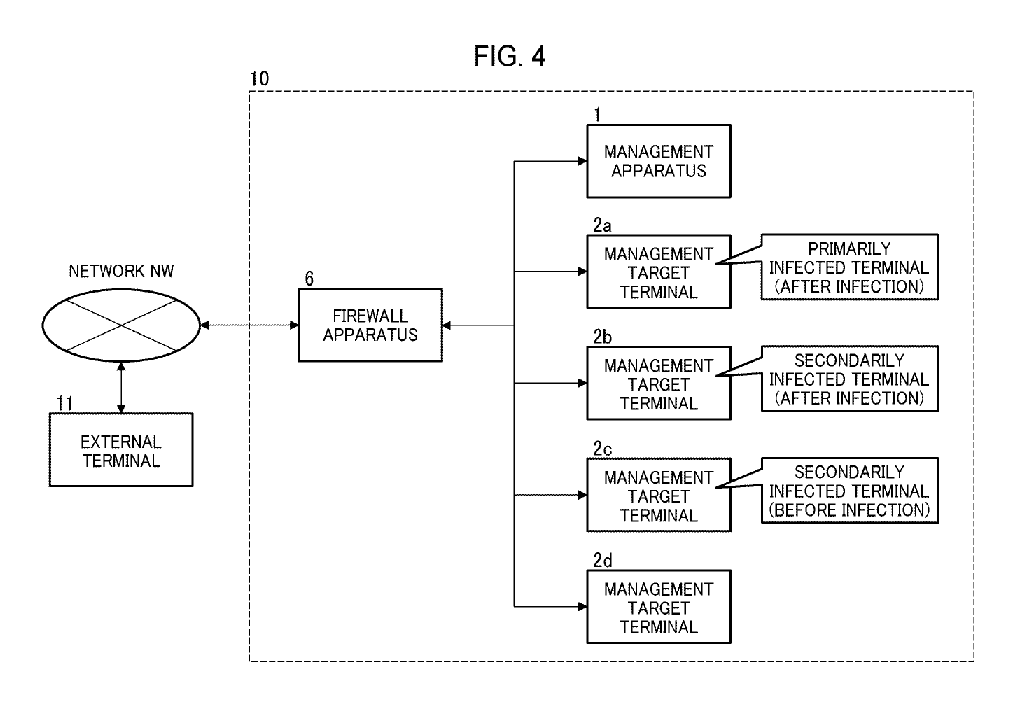

Thereafter, as depicted in FIG. 4, the malware infecting the management target terminals 2a, 2b, and 2c starts activities when latent periods of the respective kinds of malware elapse. Note that, in the example depicted in FIG. 4, the malware infecting the management target terminals 2a and 2b start activities.

An administrator uses, for example, infection detecting product in order to detect the infection of the malware. The infection detecting product is, for example, software installed in the management apparatus 1. The infection detecting product detects infection of the malware in the management target terminals 2 by performing monitoring of communication determined to be harmful that flows on a management target network.

However, when the malware infecting the management target terminals 2 is latent, the malware does not perform communication with the other management target terminals 2. Therefore, until the malware infecting the management target terminals 2 start activities, the infection detecting product is unable to detect the infection of the management target terminals 2 by the malware. Specifically, in the example depicted in FIG. 3, the infection detecting product is unable to distinguish the management target terminals 2a, 2b, and 2c that are already infected with the malware and in which the malware is latent and the management target terminal 2d not infected with the malware.

Therefore, when the administrator specifies the management target terminals 2 in which the malware is latent, the administrator refers to information indicating the other management target terminals 2 accessed by the management target terminal 2 in which the malware is detected and information such as user IDs used in accessing the other management target terminals 2. Consequently, the administrator is capable of specifying the management target terminals 2 that are already affected with the malware but in which the malware is latent. The administrator is capable of performing a detailed investigation on the management target terminals 2 that are likely to be infected with the malware and taking measures such as extermination of the malware.

However, a latent period of some malware exceeds half a year. Therefore, in this case, in order to specify the management target terminals 2 in which the malware is latent, logs for a long period need to be stored.

When activities of the malware are detected, infection spread of the malware needs to be prevented. Therefore, the administrator needs to specify the management target terminals 2 infected with the malware (the management target terminals 2 in which the malware is latent) in as short a period as possible.

However, when the stored logs are used for other than specifying the management target terminals 2 infected with the malware, in specifying the management target terminals 2 infected with the malware, the administrator needs to perform conversion, analysis, and the like of the stored logs. Therefore, the administrator is sometimes unable to specify the management target terminals infected with the malware and take measures for the specified management target terminals 2 before the infection of the malware spreads.

Therefore, in this embodiment, the management apparatus 1 acquires and accumulates connection information relating to each of the management target terminals 2 and the other management target terminals 2. According to detection of the malware in management target terminals (hereinafter referred to as first management target terminals as well) included in the management target terminals 2, the management apparatus 1 specifies, according to the connection information, the other management target terminals 2 (hereinafter referred to as monitoring target terminals 2 as well) that are likely to be infected with the malware.

Consequently, the management apparatus 1 is capable of specifying the monitoring target terminals 2 in a short period after detecting the malware in the first management target terminals. Therefore, the management apparatus 1 is capable of quickly taking measures for the monitoring target terminals 2 (e.g., extermination of the malware). It is possible to suppress spread of damages involved in the infection of the malware.

Hardware Configuration of the Management Apparatus

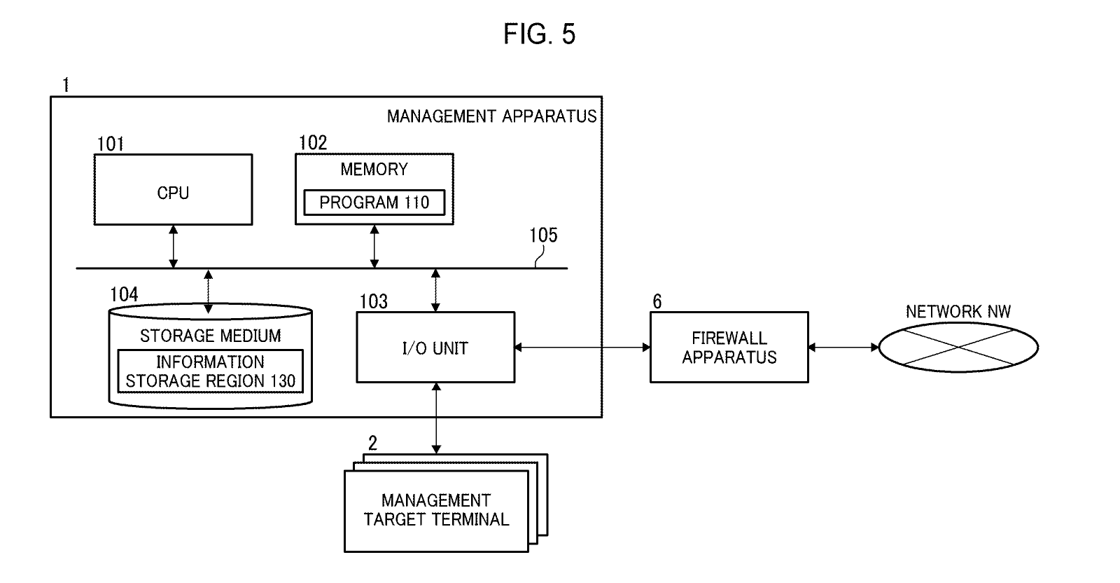

The configuration of the information processing system 10 is explained. FIG. 5 is a diagram for explaining the hardware configuration of the management apparatus 1.

The management apparatus 1 includes a CPU 101, which is a processor, a memory 102, an external interface (an I/O unit) 103, and a storage medium 104. The units are connected to one another via a bus 105.

The storage medium 104 stores, in a program storage region (not depicted in the figure) in the storage medium 104, a program 110 (hereinafter referred to as management program 110 as well) for performing, for example, processing for specifying the management target terminals 2 in which detection of malware needs to be performed (hereinafter referred to as terminal specifying processing).

As depicted in FIG. 5, during execution of the program 110, the CPU 101 loads the program 110 to the memory 102 from the storage medium 104 and performs the terminal specifying processing or the like in cooperation with the program 110.

The storage medium 104 includes an information storage region 130 (hereinafter referred to as storing unit 130 as well) that stores information used when the terminal specifying processing or the like is performed.

The external interface 103 performs communication with the management target terminals 2. The external interface 103 performs communication with the network NW via the firewall apparatus 6.

Software Configuration of the Management Apparatus

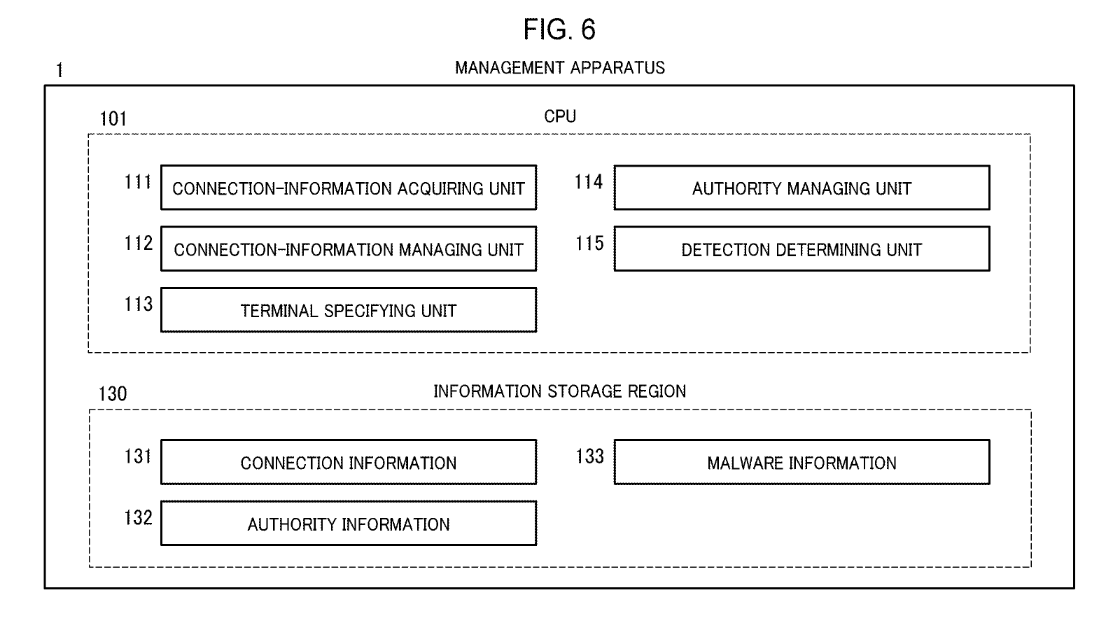

The software configuration of the management apparatus 1 is explained. FIG. 6 is a functional block diagram of the management apparatus 1 depicted in FIG. 5. The CPU 101 cooperates with the program 110 to thereby function as a connection-information acquiring unit 111, a connection-information managing unit 112, a terminal specifying unit 113, an authority managing unit 114, and a detection determining unit 115. In the information storage region 130 (hereinafter referred to as storing unit 130 as well), connection information 131, authority information 132, and malware information 133 are stored.

The connection-information acquiring unit 111 acquires the connection information 131 from the management target terminals 2. The connection information 131 is history information on connection of the management target terminals 2 to the other management target terminals 2.

Specifically, the connection-information acquiring unit 111 accesses the management target terminals 2 and acquires the connection information 131, for example, at periodical timing (e.g., every one hour). In this case, the connection-information acquiring unit 111 accesses the management target terminals 2 by referring to, for example, terminal information (not depicted in the figure) for specifying the management target terminals 2. Specific examples of the connection information 131 are explained below.

The connection-information managing unit 112 stores the connection information 131 acquired by the connection-information acquiring unit 111 in the information storage region 130.

When detecting the management target terminals (the first management target terminals) which is infected with malware among the management target terminals 2, the terminal specifying unit 113 refers to the connection information 131 stored (accumulated) in the information storage region 130. The terminal specifying unit 113 specifies the management target terminals 2 (the monitoring target terminals 2) in which a detection check of the malware needs to be performed.

Specifically, the terminal specifying unit 113 extracts, for example, among the connection information 131 stored in the information storage region 130, user information used when the management target terminals 2 in which malware is detected perform connection to the other management target terminals 2. The user information is, for example, user IDs and passwords used by the business operators in performing work in the management target terminals 2. The terminal specifying unit 113 specifies, according to the extracted user information, the management target terminals 2 in which the detection check of the malware needs to be performed. Consequently, the administrator is capable of specifying the management target terminals 2 which is likely to be infected with the malware (the management target terminals 2 that are likely to be infected with the malware) and taking measures such as extermination of the malware. A specific example of processing performed by the terminal specifying unit 113 is explained below.

The authority managing unit 114 performs management of the authority information 132. The authority information 132 is information including user information usable by the business operators in the management target terminals 2. When detecting the first management target terminals, the authority managing unit 114 prohibits all the management target terminals 2 from using user information (hereinafter, first user information) used by the first management target terminals when being connected to the other management target terminals 2. Specifically, the authority managing unit 114 updates the authority information 132 to disable the business operators to use the first user information.

When the terminal specifying unit 113 specifies the management target terminals 2 in which the detection check of the malware is performed, the detection determining unit 115 refers to the malware information 133 stored in the information storage region 130. The malware information 133 is information concerning the malware detected from the first management target terminals. Specifically, the malware information 133 includes, for example, an infection method of the malware infecting the first management target terminals and a file name, a file size, and a fingerprint of a file, which is an infection source.

The detection determining unit 115 determines, by referring to the malware information 133, whether malware same as the malware detected from the first management target terminals is detected from the management target terminal 2 specified by the terminal specifying unit 113.

### Overview of a First Embodiment

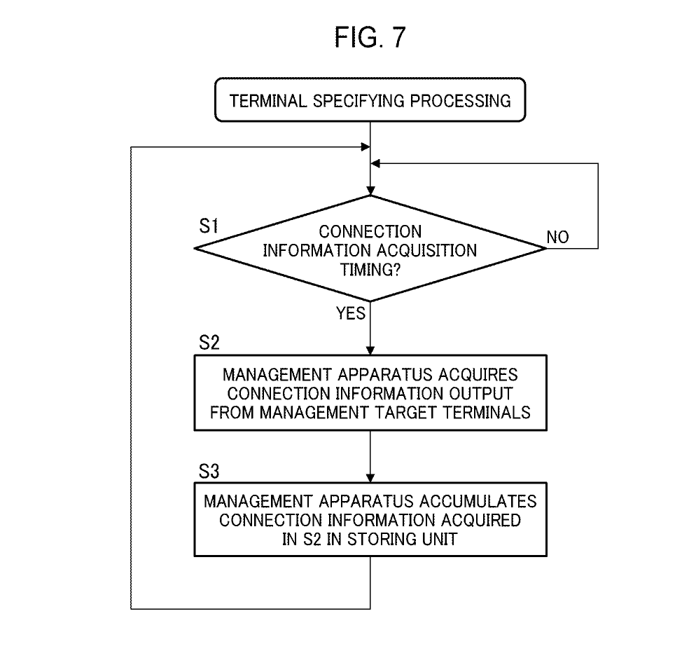

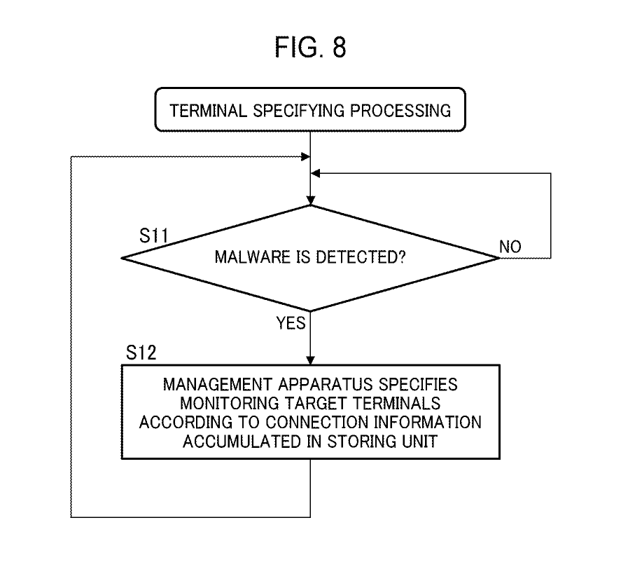

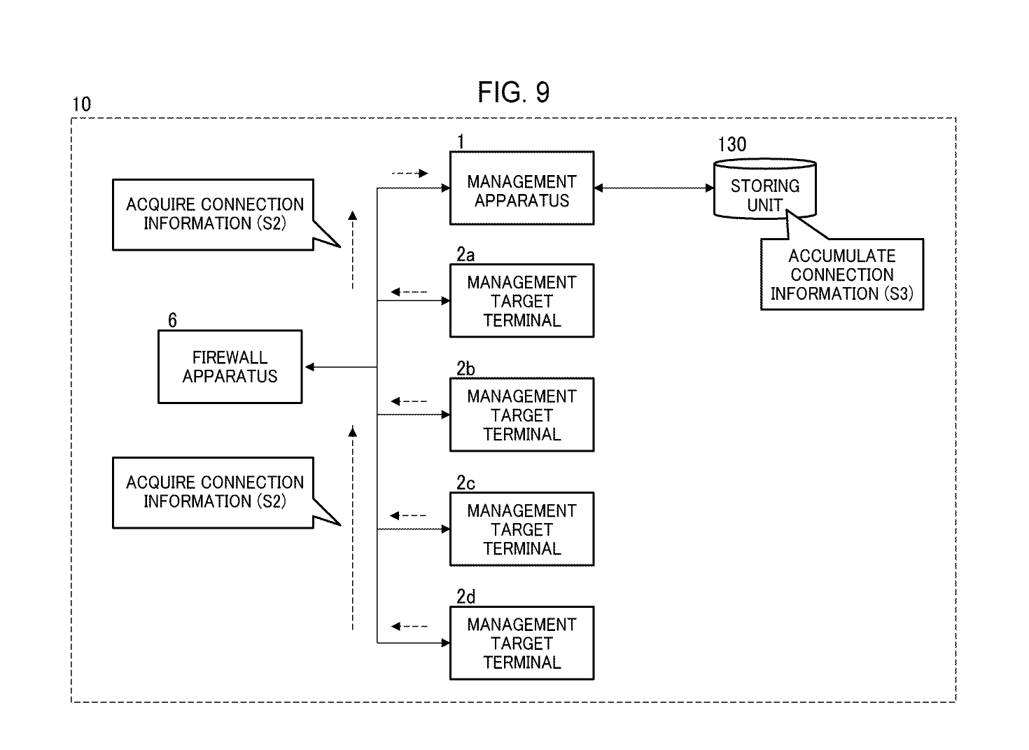

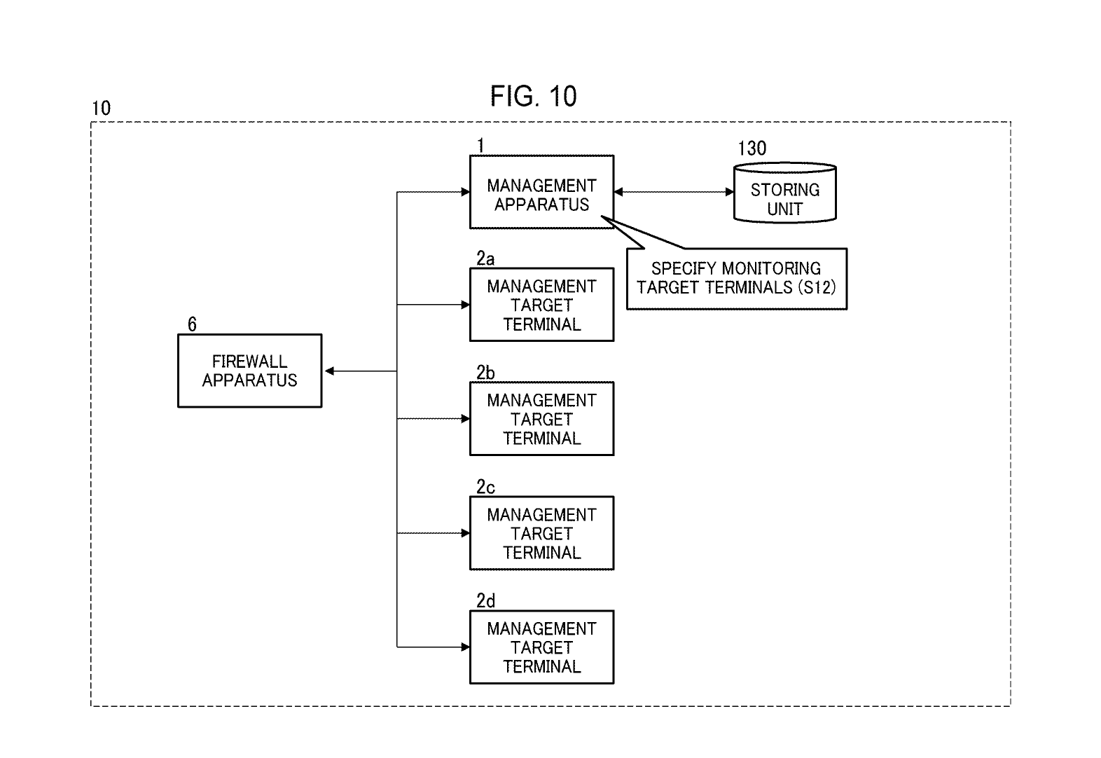

An overview of a first embodiment is explained. FIGS. 7 and 8 are flowcharts for explaining an overview of terminal specifying processing in the first embodiment. FIGS. 9 and 10 are diagrams for explaining the overview of the terminal specifying processing in the first embodiment. The overview of the terminal specifying processing depicted in FIGS. 7 and 8 is explained with reference to FIGS. 9 and 10.

Processing in Accumulating Connection Information

As depicted in FIG. 7, the management apparatus 1 stays on standby until connection information acquisition timing (NO in S1). The connection information acquisition timing is, for example, periodical timing (e.g., every one hour).

When the connection information acquisition timing comes (YES in S1), as indicated by a broken line arrow in FIG. 9, the management apparatus 1 acquires, for example, the connection information 131 output by the management target terminals 2 (S2). The management apparatus 1 may perform the acquisition of the connection information 131 by receiving the connection information 131 transmitted by the management target terminals 2.

Thereafter, as depicted in FIG. 9, the management apparatus 1 accumulates the acquired connection information 131 in the storing unit 130 (S3).

The management apparatus 1 extracts, for example, among the connection information 131 acquired from the management target terminals 2, only information at least needed to specify the other management target terminals 2 to which the management target terminals 2 are connected and accumulates the information in the storing unit 130 as the connection information 131. That is, the management apparatus 1 performs accumulation of, among the information included in the connection information 131 acquired from the management target terminals 2, only information excluding information not needed to specify the other management target terminals 2 to which the management target terminals 2 are connected.

Consequently, even the connection information 131 needs to be stored for a long period (e.g., half a year or more), the management apparatus 1 is capable of suppressing the capacity of the storage medium 104 explained with reference to FIG. 5.

After detecting the management target terminals 2 (the first management target terminals) which is infected with the malware, when specifying the management target terminals 2 (the monitoring target terminals 2) in which the detection check of the malware needs to be performed, the management apparatus 1 does not need to perform an analysis or the like on the accumulated information. Therefore, the management apparatus 1 is capable of quickly specifying the management target terminal 2 in which the malware is latent and quickly taking measures such as extermination of the malware. Therefore, the management apparatus 1 is capable of suppressing spread of damages due to infection of the malware.

Note that the management apparatus 1 may acquire, from the management target terminals 2, only information at least needed to specify the other management target terminals 2 to which the management target terminals 2 are connected and accumulate the acquired information in the storing unit 130 as the connection information 131.

Processing in Specifying the Management Target Terminals in which the Detection Check is Performed

On the other hand, as depicted in FIG. 8, the management apparatus 1 stays on standby until the management target terminals 2 which is infected with malware is detected (NO in S11). Specifically, when the administrator performs, for example, an input to the effect that there are the management target terminals 2 infected with the malware, the management apparatus 1 may perform detecting the management target terminals 2 (the first management target terminals) which is infected with the malware.

When detecting the management target terminals 2 which is infected with the malware (YES in S11), as depicted in FIG. 10, the management apparatus specifies, according to the connection information 131 accumulated in the storing unit 130, the management target terminals 2 (the monitoring target terminals 2) in which the detection check of the malware is performed (S12).

In this way, according to the first embodiment, the management apparatus 1 acquires the connection information 131 at the time when the management target terminals 2 are connected to the other management target terminals 2 and accumulates the connection information 131 in the storing unit 130. The management apparatus 1 specifies, according to detection of malware that performs a harmful action in the first management target terminal included in the management target terminals 2, on the basis of the connection information 131 of the first management target terminals accumulated in the storing unit 130, the management target terminals 2 that need to be monitored.

Consequently, the management apparatus 1 can specify, after detection of activities of the malware, in a short period, the management target terminals 2 which is likely to be infected with the malware.

### Details of the First Embodiment

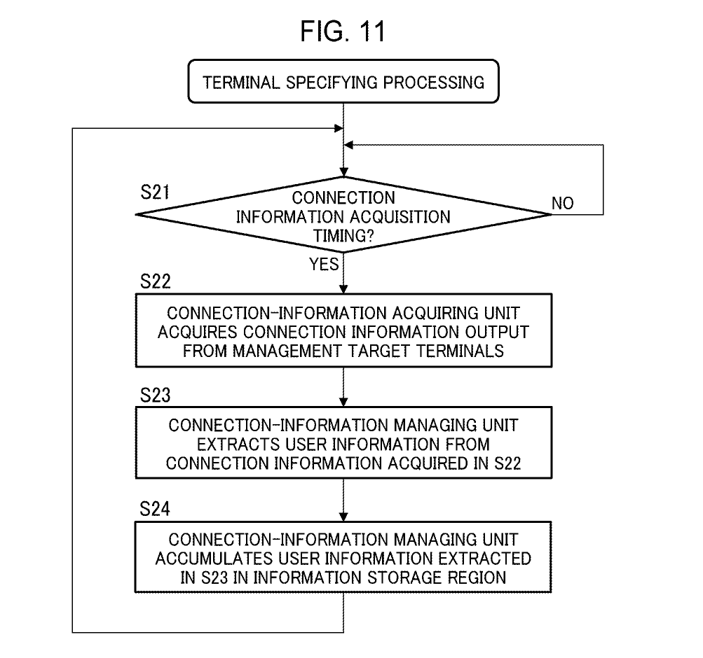

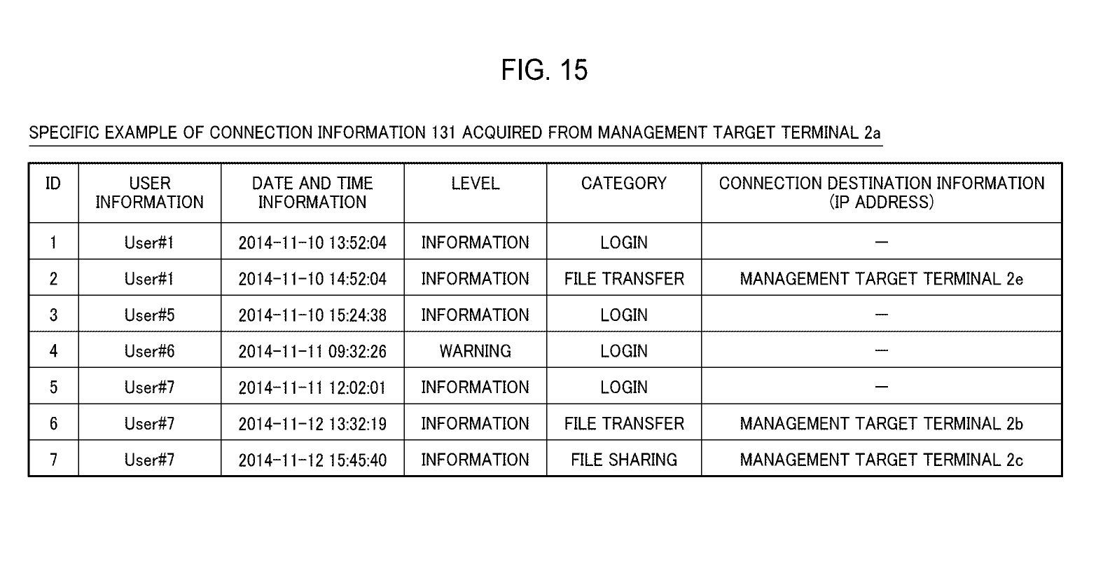

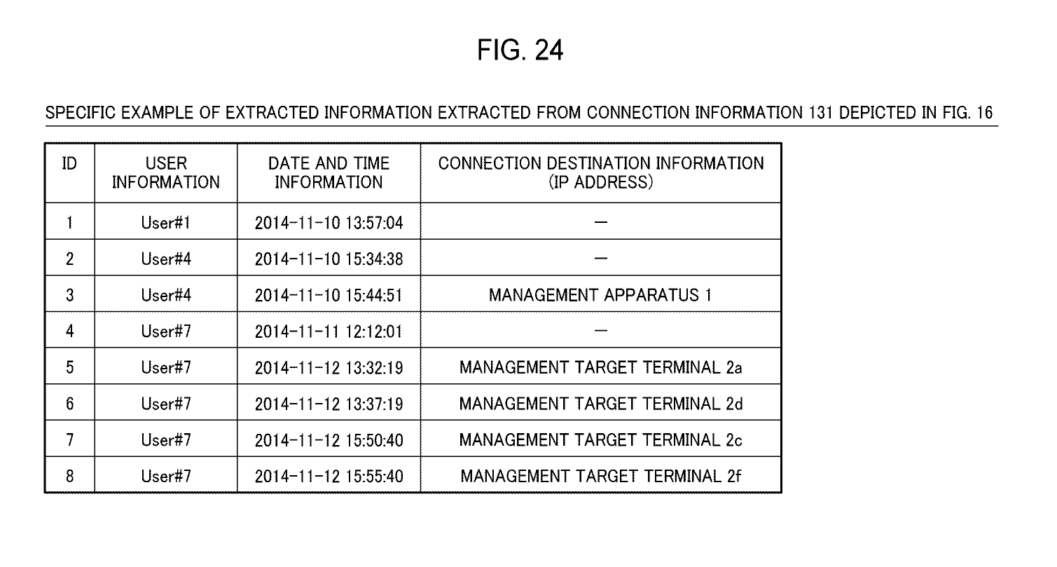

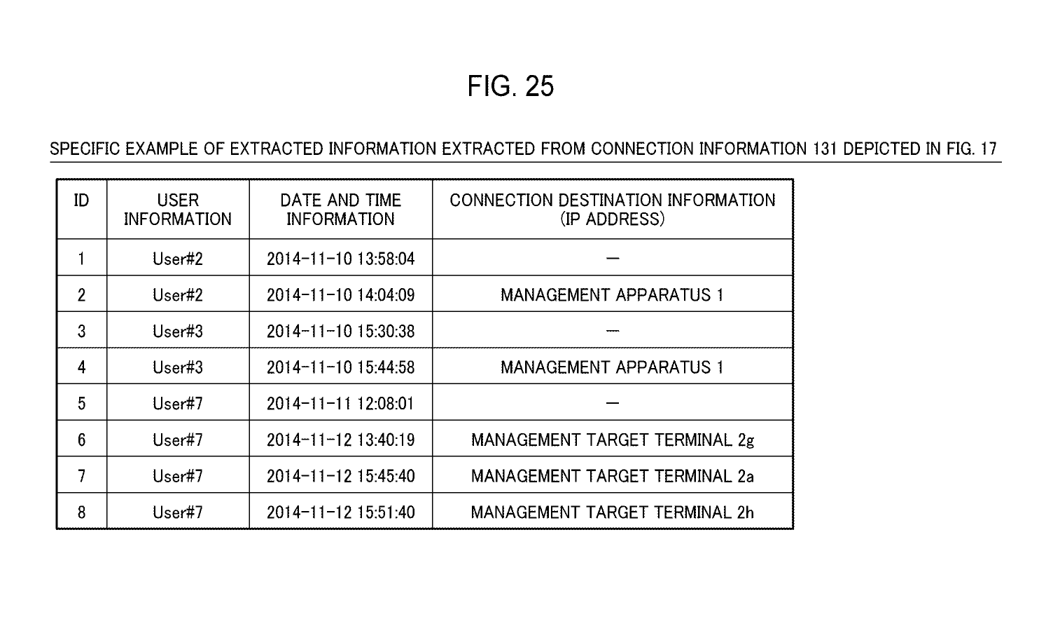

Details of the first embodiment are explained. FIGS. 11 to 14 are flowcharts for explaining details of the terminal specifying processing in the first embodiment. FIGS. 15 to 28 are diagrams for explaining the details of the terminal specifying processing in the first embodiment. The terminal specifying processing depicted in FIGS. 11 to 14 is explained with reference to FIGS. 15 to 28.

Note that, in the following explanation, it is assumed that the information processing system 10 includes nine management target terminals 2a, 2b, 2c, 2d, 2e, 2f, 2g, 2h, and 2i. It is assumed that, among the management target terminals, three management target terminals 2a, 2b, and 2c have been infected with the same malware and the infecting malware has already started activities.

Processing in Accumulating the Connection Information

First, as depicted in FIG. 11, the connection-information acquiring unit 111 of the management apparatus 1 stays on standby until connection information acquisition timing (NO in S21). When the connection information acquisition timing comes (YES in S21), the connection-information acquiring unit 111 acquires, for example, the connection information 131 output from the management target terminals 2 (S22). Specific examples of the connection information 131 are explained below.

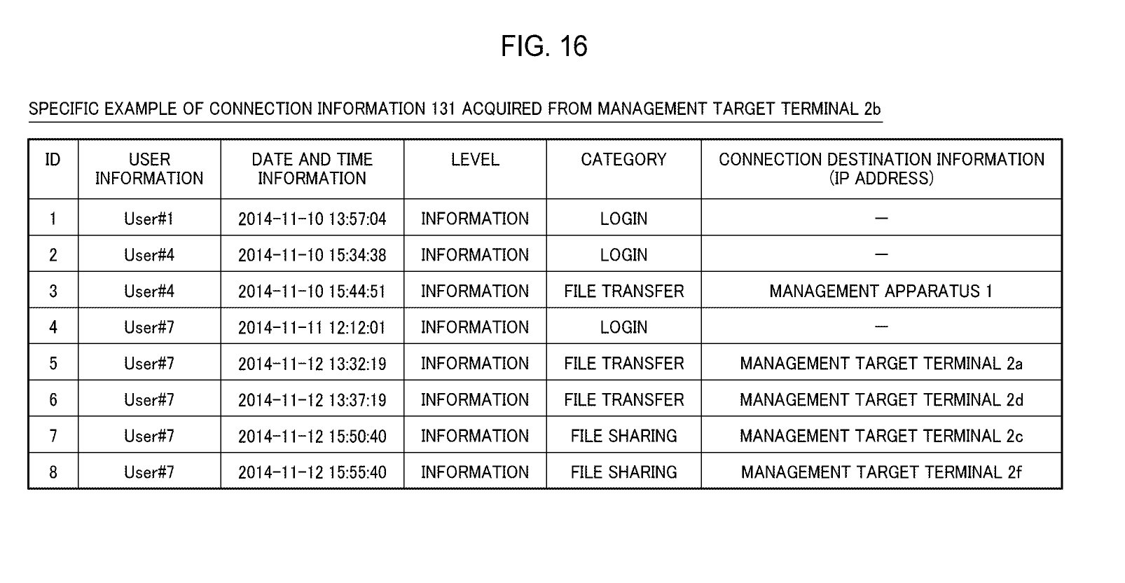

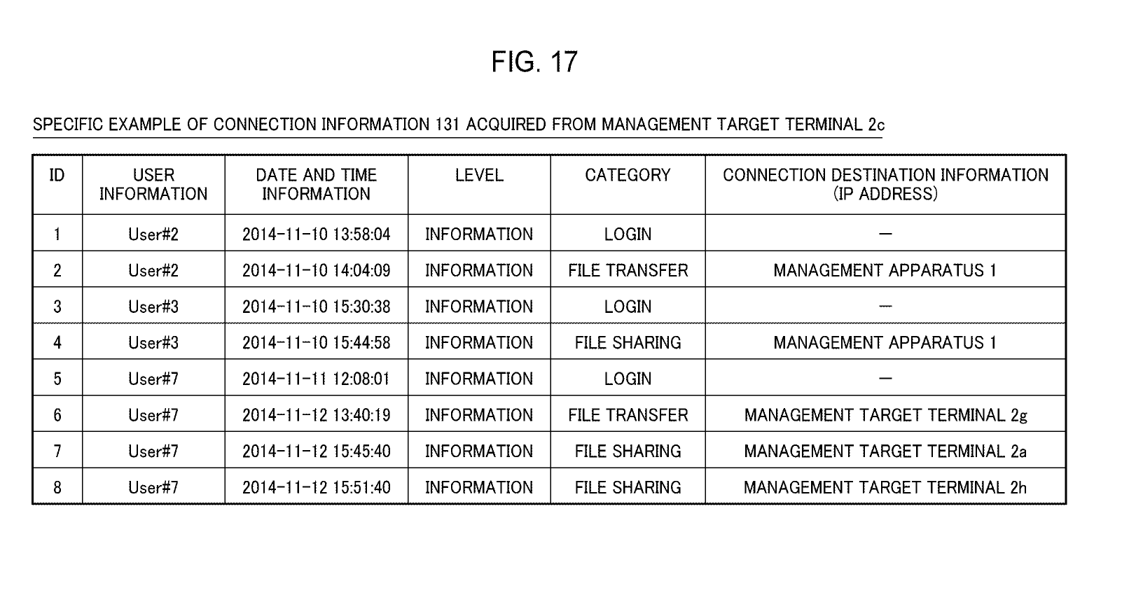

FIG. 15 is a diagram for explaining a specific example of the connection information 131 acquired from the management target terminal 2a by the management apparatus 1. FIG. 16 is a diagram for explaining a specific example of the connection information 131 acquired from the management target terminal 2b by the management apparatus 1. FIG. 17 is a diagram for explaining a specific example of the connection information 131 acquired from the management target terminal 2c by the management apparatus 1.

The connection information 131 depicted in FIGS. 15 to 17 respectively includes, as items, an “ID” for identifying output respective kinds of information, a “user information” indicating user information used when work is performed in the management target terminals 2, and a “date and time information” indicating generation date and time of the respective kinds of information.

Further, the connection information 131 depicted in FIGS. 15 to 17 respectively includes, as an item, a “level” indicating importance of the respective kinds of information. In the “level”, for example, an “information” indicating information that does not need to be treated by the administrator and a “warning” indicating information that does not need to be treated by the administrator but needs to be paid attention are set. In the “level”, for example, an “error” indicating information that is output during abnormality occurrence in the management target terminals 2 and needs to be treated by the administrator is set.

The connection information 131 depicted in FIGS. 15 to 17 includes, as items, a “category” indicating categories of the output respective kinds of information and a “connection destination information”, which is information for specifying a connection destination in the case of connection to the other management target terminals 2. In the “connection destination information”, for example, an Internet Protocol (IP) address of the connection destination is set.

Specifically, in the connection information 131 depicted in FIG. 15, in information, the “ID” of which is “1”, “User#1” is set as the “user information”, “2014-11-10 13:52:04” is set as the “date and time information”, and the “information” is set as the “level”. Further, in the connection information 131 depicted in FIG. 15, in the information, the “ID” of which is “1”, “login” is set as the “category” and the “connection destination information” is blank.

In the connection information 131 depicted in FIG. 16, in information, the “ID” of which is “3”, “User#4” is set as the “user information”, “2014-11-10 15:44:51” is set as the “date and time information”, and the “information” is set as the “level”. Further, in the connection information 131 depicted in FIG. 16, in the information, the “ID” of which is “3”, for example, “file transfer” is set as the “category” and “management apparatus 1” is set as the “connection destination information”.

Further, in the connection information 131 depicted in FIG. 17, for example, in information, the “ID” of which is “6”, “User#7” is set as the “user information”, “2014-11-12 13:40:19” is set as the “date and time information”, and the “information” is set as the “level”. Further, in the connection information 131 depicted in FIG. 17, in the information, the “ID” of which is “6”, for example, “file transfer” is set as the “category” and “management target terminal 2g” is set as the “connection destination information”. Explanation of the other information in FIGS. 15 to 17 is omitted.

That is, as explained below, the management apparatus 1 acquires the connection information 131 respectively from the management target terminals 2 (the first management target terminals) which is infected with malware and performs an analysis across the board concerning the acquired connection information 131 to thereby specify the management target terminals 2 in which the malware is likely to be latent.

Referring back to FIG. 11, the connection-information managing unit 112 of the management apparatus 1 extracts information including user information from the connection information 131 acquired by the connection-information acquiring unit 111 in S22 (S23). The connection-information managing unit 112 accumulates, for example, the information extracted in S23 (hereinafter referred to as extracted information as well) in the information storage region 130 as the connection information 131 (S24). A specific example of the extracted information is explained below.

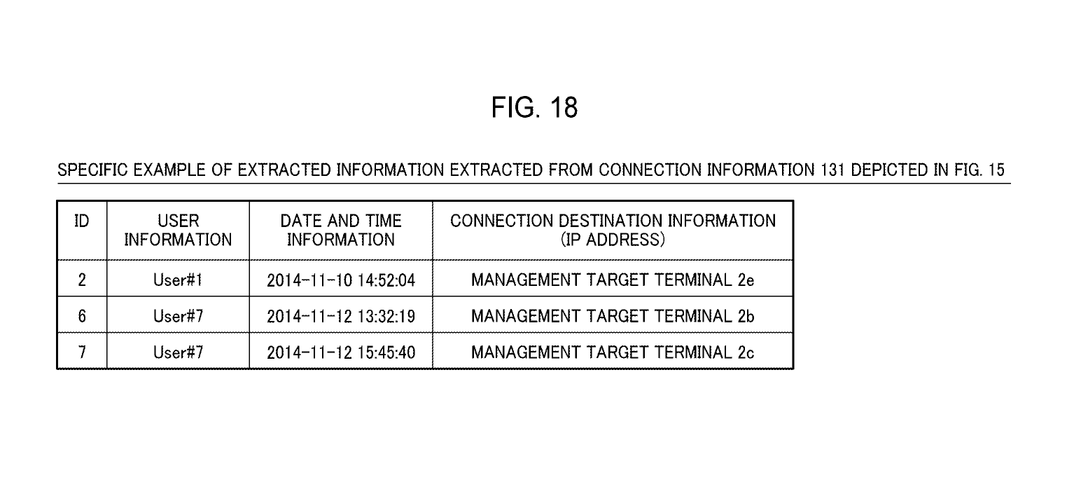

FIGS. 18 to 20 are diagrams for explaining specific examples of extracted information extracted from the connection information 131 by the connection-information managing unit 112. The extracted information depicted in FIG. 18 is information, in which information corresponding to the item of “category” is “file transfer” or “file sharing”, extracted by the connection-information managing unit 112 among information corresponding to the items “user information”, “date and time information”, and “connection destination information” included in the connection information 131 depicted in FIG. 15.

Specifically, as the extracted information depicted in FIG. 18, only information of the items corresponding to “user information”, “date and time information”, and “connection destination information” among the connection information 131 depicted in FIG. 15 is extracted. As the extracted information depicted in FIG. 18, only information, in which information corresponding to the item of “category” is “file transfer” or “file sharing” among the connection information 131 depicted in FIG. 15 (information, the “ID” of which is “2”, “6”, and “7”, among the connection information 131 depicted in FIG. 15) is extracted.

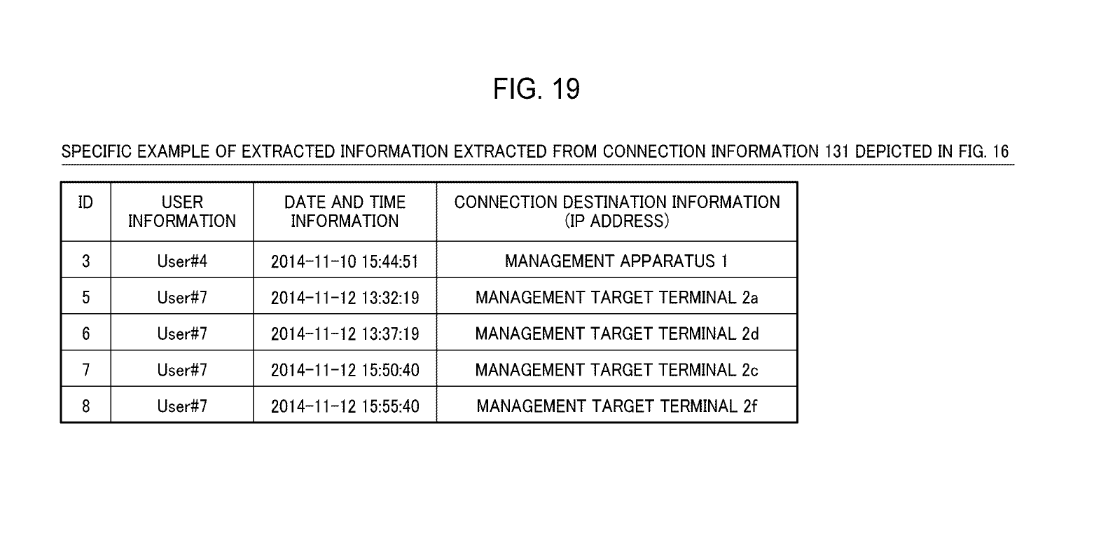

Similarly, the extracted information depicted in FIG. 19 is information, in which information corresponding to the item of “category” is “file transfer” or “file sharing”, extracted by the connection-information managing unit 112 among information corresponding to the items of “user information”, “date and time information”, and “connection destination information” included in the connection information 131 depicted in FIG. 16.

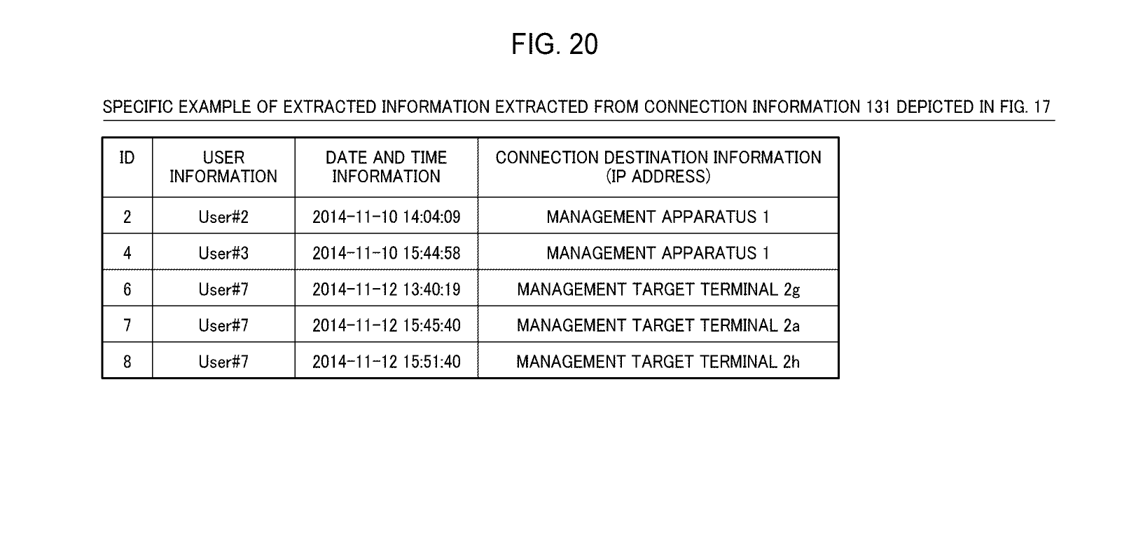

Further, the extracted information depicted in FIG. 20 is information, in which information corresponding to the item of “category” is “file transfer” or “file sharing”, extracted by the connection-information managing unit 112 among information corresponding to the items of “user information”, “date and time information”, and “connection destination information” included in the connection information 131 depicted in FIG. 17.

Note that, in the following explanation, for convenience of explanation, it is assumed that the extracted information depicted in FIGS. 18 to 20 includes information of the item of “ID” in addition to the information of the items of “user information”, “date and time information”, and “connection destination information”. Content of the extracted information depicted in FIGS. 19 and 20 is the same as the content of the extracted information explained with reference to FIG. 18. Therefore, detailed explanation of the extracted information is omitted.

That is, in the extracted information depicted in FIGS. 18 to 20, only minimum information for enabling, when the management target terminals 2 (the first management target terminals) which is infected with malware is detected, a detection check of the same malware is included. Therefore, in the extracted information depicted in FIGS. 18 to 20, the information corresponding to the items of “level” and “category” among the information respectively included in the connection information 131 depicted in FIGS. 15 to 17 is not included. Further, in the extracted information depicted in FIGS. 18 to 20, the information, in which the item of “category” is “login”, among the information respectively included in the connection information 131 depicted in FIGS. 15 to 17 is not included.

Consequently, even when the management apparatus 1 needs to store the connection information 131 for a long period (e.g., half a year or more), compared with when the management apparatus 1 stores all the connection information 131 acquired from the management target terminals 2, it is possible to reduce the capacity of the information storage region 130 (the storage medium 104). The management apparatus 1 stores only information needed to specify the other management target terminals 2 to which the management target terminals 2 are connected. Consequently, when detecting the management target terminals 2 which is infected with malware, the management apparatus 1 does not need to perform an analysis based on the connection information 131, tabulation of new information, and the like. Therefore, the management apparatus 1 is capable of quickly specifying the management target terminals 2 in which the malware is latent.

Note that, for example, when determining that information needed by the administrator to perform the detection check of malware is only the “user information”, the connection-information managing unit 112 may extract only information corresponding to the “user information” included in the connection information 131 depicted in FIGS. 15 to 17. The connection-information managing unit 112 may store only the extracted information corresponding to the “user information” in the information storage region 130 as the connection information 131.

The connection-information managing unit 112 may create information obtained by tabulating the extracted information explained with reference to FIGS. 18 to 20 (hereinafter referred to as tabulated information as well). In this case, the connection-information managing unit 112 may accumulate only the tabulated information in the information storage region 130. A specific example of the tabulated information is explained below.

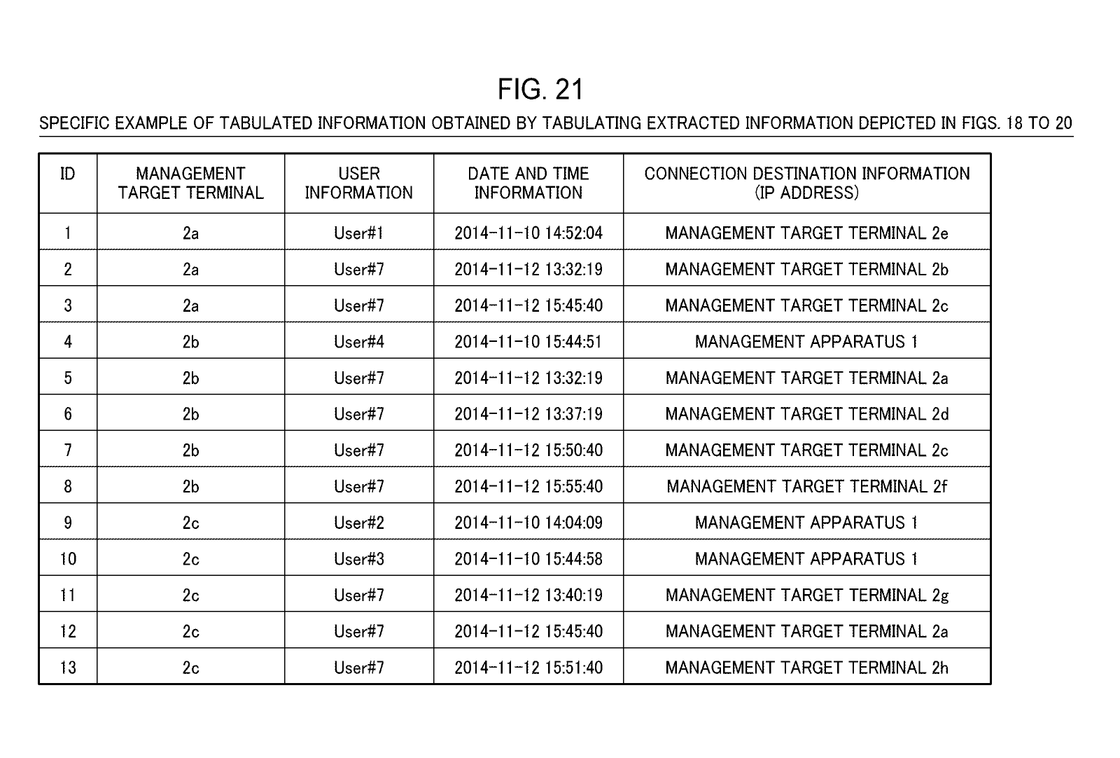

FIG. 21 is a diagram for explaining the specific example of the tabulated information. The tabulated information depicted in FIG. 21 includes, as an item, a “management target terminal”, which is information for specifying the management target terminals 2 corresponding to the respective kinds of information, in addition to the “ID”, the “user information”, the “date and time information”, and the “connection destination information” included in the extracted information explained with reference to FIGS. 18 to 20.

Specifically, in the tabulated information depicted in FIG. 21, as information, the “management target terminal” of which is “2a” (information, the “ID” of which is “1” to “3”), information same as the information included in the extracted information explained with reference to FIG. 18 is set. In the tabulated information depicted in FIG. 21, as information, the “management target terminal” of which is “2b” (information, the “ID” of which is “4” to “8”), information same as the information included in the extracted information explained with reference to FIG. 19 is set. Further, in the tabulated information depicted in FIG. 21, as information, the “management target terminal” of which is “2c”(information, the “ID” of which is “9” to “13”), information same as the information included in the extracted information explained with reference to FIG. 20 is set.

That is, in this case, the connection-information managing unit 112 is capable of specifying, referring to the tabulated information, the management target terminals 2 corresponding to the respective kinds of information included in the tabulated information. Consequently, the connection-information managing unit 112 does not need to manage a plurality of kinds of information in the information storage region 130 unlike the extracted information explained with reference to FIGS. 18 to 20.

Processing in Specifying the Management Target Terminals in which the Detection Check is Performed

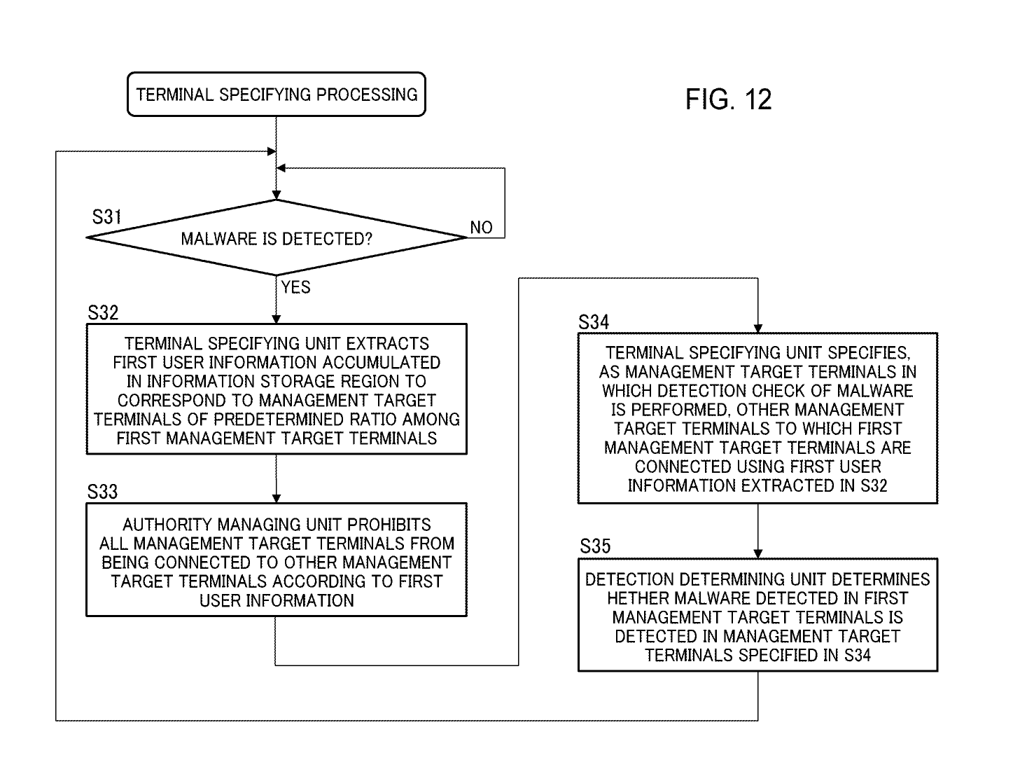

On the other hand, as depicted in FIG. 12, the terminal specifying unit 113 of the management apparatus 1 stays on standby until the management target terminals 2 (the first management target terminals) which is infected with malware is detected (NO in S31).

When detecting the management target terminals 2 which is infected with the malware (YES in S31), the terminal specifying unit 113 of the management apparatus 1 extracts user information (first user information) accumulated in the information storage region 130 to correspond to the management target terminals 2 at least a predetermined ratio (hereinafter referred to as first threshold as well) among the first management target terminals (S32).

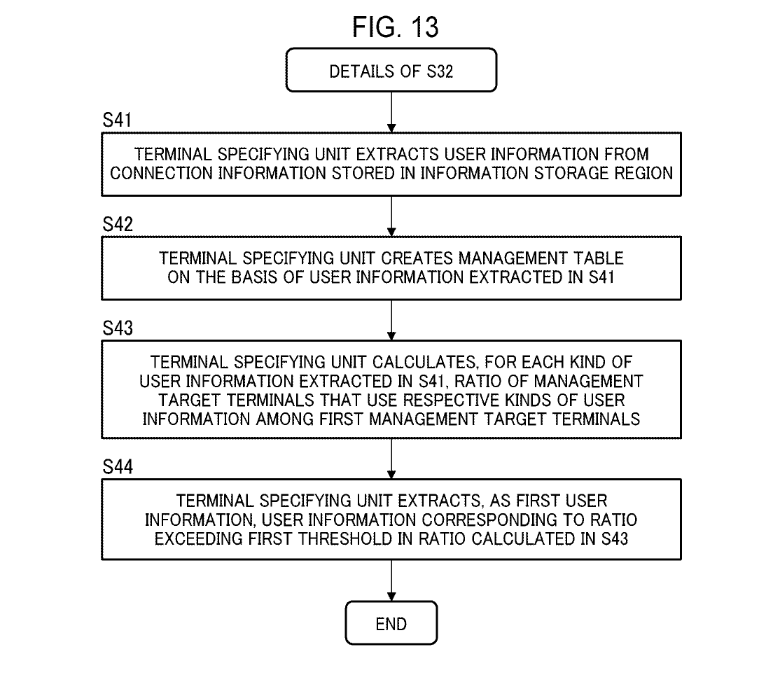

That is, when there are a plurality of first management target terminals infected with the same malware, it is sometimes clear that the first management target terminals are highly likely to perform an operation such as file transfer according to the same user information. In such a case, the terminal specifying unit 113 extracts the first user information used by the management target terminals 2 equal to or more than the first threshold among the first management target terminals. Consequently, the terminal specifying unit 113 is capable of specifying the user information (the first user information) which is highly likely to be used when the first management target terminals operate. A specific example of the processing in S32 is explained with reference to FIG. 13.

Specific Example of the Processing in S32

As depicted in FIG. 13, the terminal specifying unit 113 refers to, for example, the connection information 131 stored in the information storage region 130 (the extracted information explained with reference to FIGS. 18 to 20 or the tabulated information explained with reference to FIG. 21). The terminal specifying unit 113 respectively extracts the user information included in the extracted information or the tabulated information (S41).

Specifically, the terminal specifying unit 113 extracts, for example, the “User#1” and the “User#7”, which are the “user information” included in the information depicted in FIG. 18. The terminal specifying unit 113 extracts, for example, the “User#4” and the “User#7”, which are the “user information” included in the information depicted in FIG. 19. Further, the terminal specifying unit 113 extracts, for example, the “User#2”, the “User#3”, and the “User#7”, which are the “user information” included in the information depicted in FIG. 20.

The terminal specifying unit 113 creates, for example, a management table on the basis of the user information extracted in S41 (S42). A specific example of the management table is explained below.

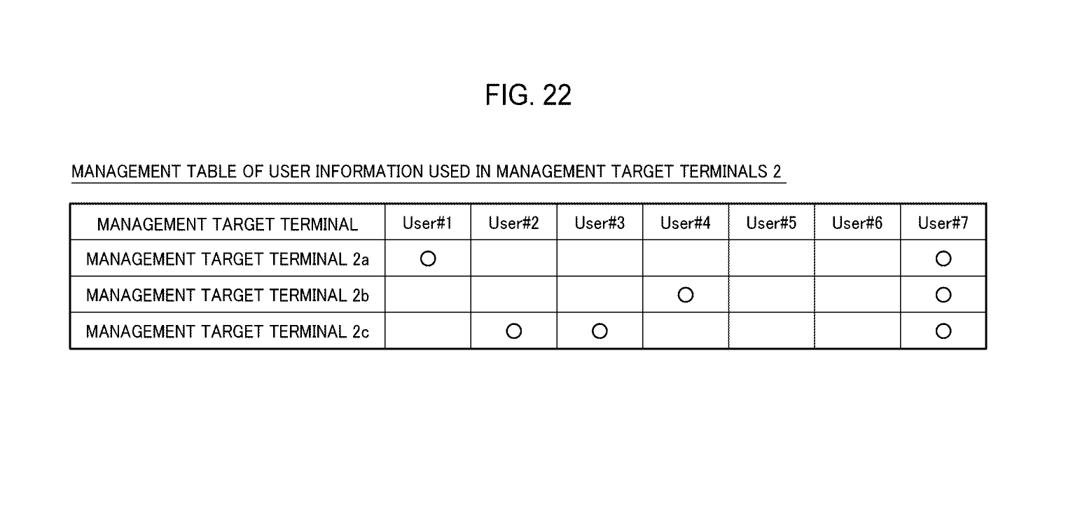

FIG. 22 is a diagram for explaining the specific example of the management table. As depicted in FIG. 22, the terminal specifying unit 113 sets, for example, from the user information extracted in S41, “O” in columns where the “management target terminal 2a” and the “User#1” and the “User#7” correspond to each other and columns where the “management target terminal 2b” and the “User#4” and the “User#7” correspond to each other. The terminal specifying unit 113 sets, for example, from the user information extracted in S41, “O” in columns where the “management target terminal 2c” and the “User#2”, the “User#3”, and the “User#7# correspond to each other.

Thereafter, the terminal specifying unit 113 calculates, referring to the management table created in S42, for each of the kinds of user information extracted in S41, a ratio of the management target terminals 2 that use the user information among the management target terminals 2a, 2b, and 2c (S43).

Specifically, in the example depicted in FIG. 22, the “User#7# is used by all the management target terminals 2 included in the first management target terminals. Therefore, the terminal specifying unit 113 calculates “100%” as a ratio of the first management target terminals that use the “User#7”. Similarly, in the example depicted in FIG. 22, each of the “User#2”, the “User#3”, and the “User#4” is used by only one management target terminal among the first management target terminals. Therefore, the terminal specifying unit 113 calculates “33%” (effective numbers are two digits) as a ratio of the first management target terminals that use each of the “User#2”, the “User#3”, and the “User#4”.

The terminal specifying unit 113 extracts, from the information storage region 130, as the first user information, user information corresponding to the ratios more than the first threshold among the ratios calculated in S43 (S44).

Specifically, for example, when the first threshold is “60%”, the terminal specifying unit 113 extracts, as the first user information, the “User#7”, the ratio of which calculated in S43 is “100%”. That is, by performing the processing in S32, the terminal specifying unit 113 specifies that user information which is likely to be used by the malware is the “User#7”.

Note that the connection-information managing unit 112 may create extracted information by extracting all kinds of information corresponding to the “user information”, the “date and time information”, and the “connection destination information” included in the connection information 131 depicted in FIGS. 15 to 17 (S41). The extracted information created in this case is explained below.

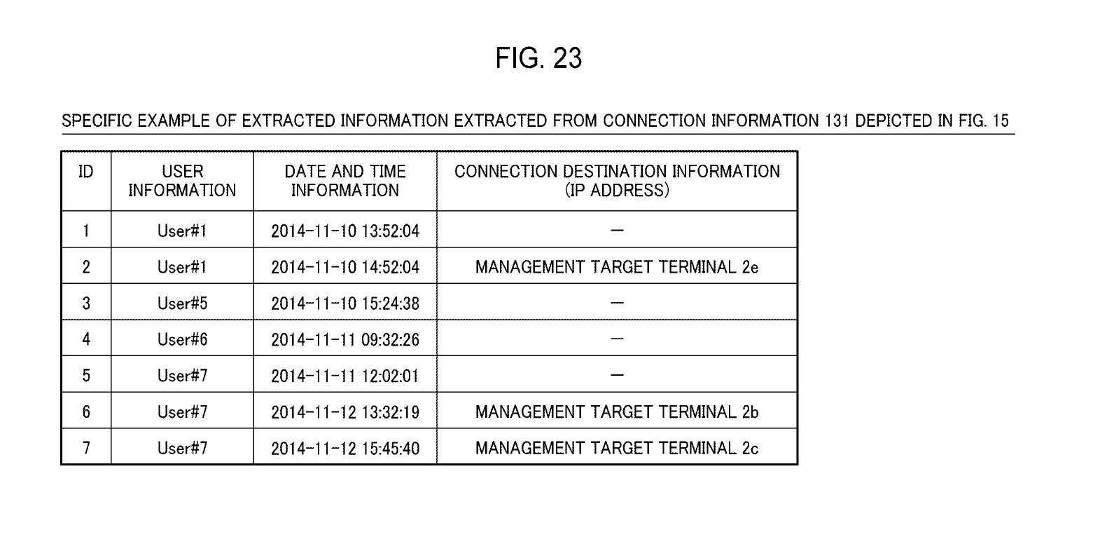

FIGS. 23 to 25 are diagrams for explaining specific examples of extracted information extracted from the connection information 131 by the connection-information managing unit 112. Specifically, as depicted in FIGS. 23 to 25, in S23, the connection-information managing unit 112 performs creation of extracted information including not only information, in which information of the item of “category” is “file transfer” or “file sharing”, but also information, in which information of the item of “category” is “login”. Consequently, the connection-information managing unit 112 is capable of performing the creation of the extracted information including information corresponding to a case in which the malware does not perform connection to the other management target terminals 2 and performs only login. Explanation of detailed information of the extracted information depicted in FIGS. 23 to 25 is omitted.

In this case, the connection-information managing unit 112 may create tabulated information on the basis of the extracted information depicted in FIGS. 23 to 25. The tabulated information created in this case is explained below.

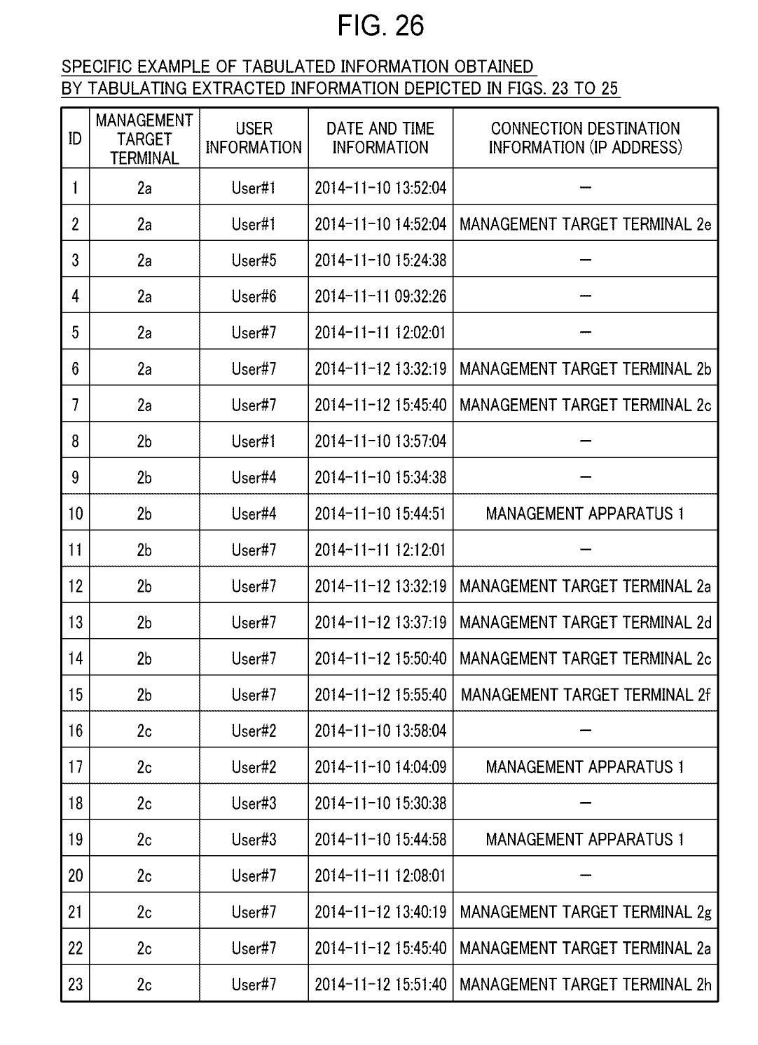

FIG. 26 is a diagram for explaining a specific example of the tabulated information. Specifically, in this case, the connection-information managing unit 112 performs the creation of the tabulated information on the basis of the extracted information explained with reference to FIGS. 23 to 25 instead of the extracted information explained with reference to FIGS. 18 to 20. Consequently, the connection-information managing unit 112 is capable of performing the creation of the tabulated information including information corresponding to a case in which the malware does not perform connection to the other management target terminals 2 and performs only login. Explanation of detailed information of the tabulated information depicted in FIG. 26 is omitted.

Further, the terminal specifying unit 113 may create, on the basis of the extracted information explained with reference to FIGS. 23 to 25 or the tabulated information explained with reference to FIG. 26, the management table in a form including information concerning users who perform only login in the first management target terminals (S42). A management table created in this case is explained below.

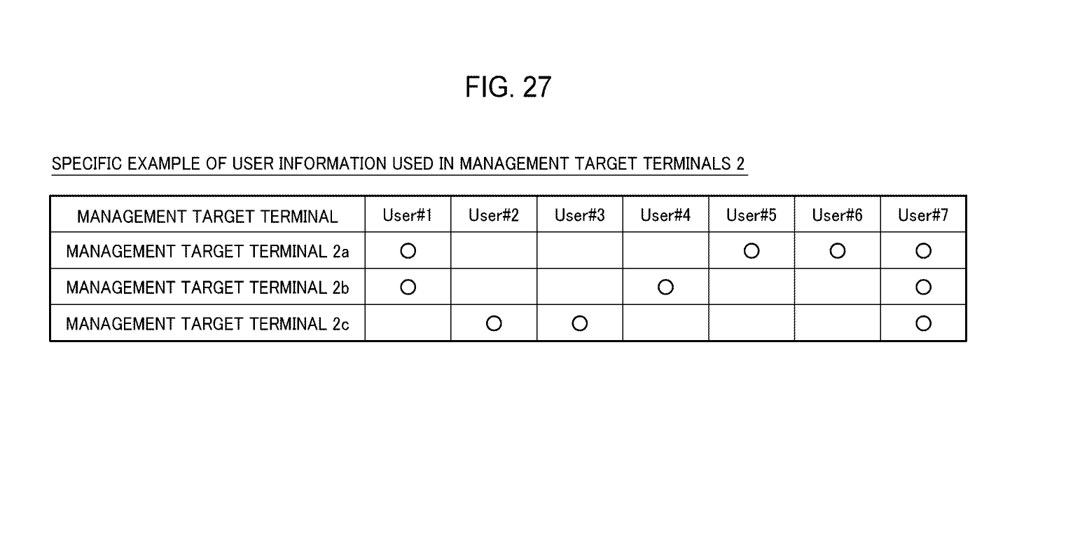

FIG. 27 is a diagram for explaining a specific example of the management table. Specifically, the terminal specifying unit 113 sets “O” in, for example, columns where the “management target terminal 2a” and the “User#1”, the “User#5”, the “User#6”, and the “User#7” correspond to each other. The terminal specifying unit 113 sets “O” in, for example, columns where the “management target terminal 2b” and the “User#1”, the “User#4”, and the “User#7” correspond to each other. Further, the terminal specifying unit 113 sets “O” in, for example, columns where the “management target terminal 2c” and the “User#2”, the “User#3”, and the “User#7” correspond to each other.

Therefore, in this case, the terminal specifying unit 113 calculates “67%” (effective numbers are two digits) as a ratio of the management target terminals that use the “User#1” among the first target terminals. That is, in this case, the terminal specifying unit 113 extracts not only the “User#7” but also “User#1” as the first user information. The terminal specifying unit 113 specifies that user information which is likely to be used by the malware is the “User#1” and the “User#7”.

Consequently, the management apparatus 1 is capable of performing the detection of malware in cases including a case in which the malware does not perform connection to the other management target terminals 2 and performs only login.

Referring back to FIG. 12, the authority managing unit 114 prohibits all the management target terminals 2 from being connected to the other management target terminals 2 according to the first user information (S33).

That is, when malware is detected in the first management target terminals, the malware is likely to continue infection to the other management target terminals 2. Therefore, the authority managing unit 114 prohibits use of user information which is likely to be used by the malware. Consequently, the management apparatus 1 is capable of suppressing further activities (spread of infection) by the malware.

The terminal specifying unit 113 specifies, as the management target terminals 2 in which the detection check of the malware is performed, the other management target terminals 2 to which any one of the first management target terminals is connected using the first user information extracted in S32 (S34). A specific example of S34 is explained below.

Specific Example of the Processing in S34

The terminal specifying unit 113 refers to, for example, the extracted information explained with reference to FIGS. 18 to 20. The terminal specifying unit 113 extracts the management target terminals 2 specified by the “connection destination information” corresponding to the first user information extracted in S32 among the extracted information included in the information depicted in FIGS. 18 to 20. In the following explanation, the first user information extracted in S32 is the “User#7”.

Specifically, the terminal specifying unit 113 extracts, referring to FIG. 18, the “management target terminal 2b” and the “management target terminal 2c” as the “connection destination information” corresponding to the information in which the “user information” is the “User#7”. Similarly, the terminal specifying unit 113 extracts, referring to FIG. 19, the “management target terminal 2a”, the “management target terminal 2d”, the “management target terminal 2c”, and the “management target terminal 2f” as the “connection destination information” corresponding to the information in which the “user information” is the “User#7”. The terminal specifying unit 113 extracts, referring to FIG. 20, the “management target terminal 2g”, the “management target terminal 2a”, and the “management target terminal 2h” as the “connection destination information” corresponding to the information in which the “user information” is the “User#7”.

The terminal specifying unit 113 specifies, excluding the management target terminals 2a, 2b, and 2c in which malware is already detected, the management target terminals 2d, 2f, 2g, and 2h as the management target terminals 2 which is likely to be infected with the malware.

On the other hand, the terminal specifying unit 113 determines that the management target terminals 2e and 2i which are not set in the “connection destination information” corresponding to information, in which the “user information” is the “User#7”, in the extracted information depicted in FIGS. 18 to 20 are the management target terminals 2 in which the malware is not detected. Consequently, the terminal specifying unit 113 is capable of specifying the management target terminals 2 which is likely to be infected with the malware.

Referring back to FIG. 12, the detection determining unit 115 determines whether the malware detected in the first management target terminals is detected in the management target terminals 2 specified in S34 (S35).

Specifically, when the malware is detected in the first management target terminals, the detection determining unit 115 refers to, for example, the malware information 133. The detection determining unit 115 acquires, for example, from the malware information 133, a file name, a file size, and a fingerprint of a file (e.g., a file likely to be an infection source) created when the first management target terminals are infected with the malware.

Subsequently, the detection determining unit 115 checks, for example, whether the file created when the first management target terminals are infected with the malware is present in the management target terminals 2 specified by the terminal specifying unit 113. When the same file is present in the management target terminals 2 specified by the terminal specifying unit 113, the detection determining unit 115 determines that the management target terminals 2 specified by the terminal specifying unit 113 are the management target terminals 2 infected with the malware with which the first management target terminals are infected.

Details of the Processing in S24

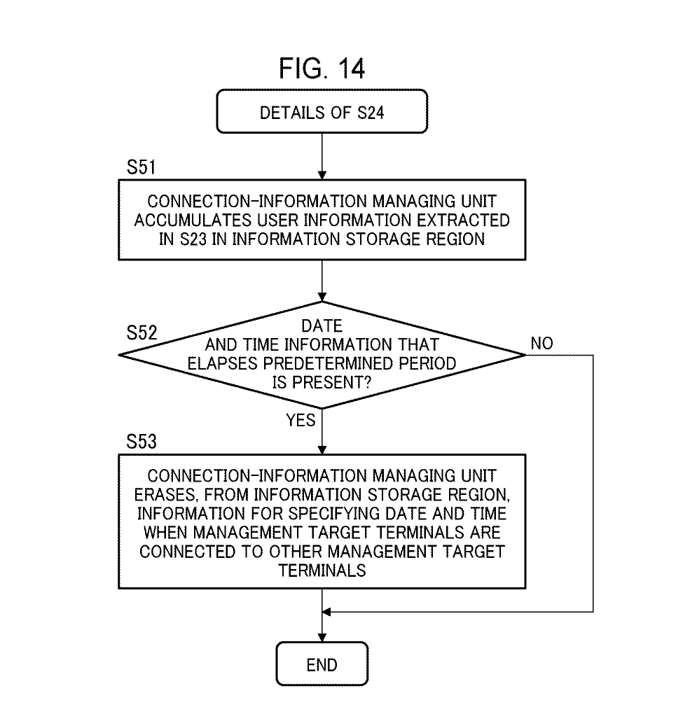

Details of the processing in S24 explained with reference to FIG. 11 are explained with reference to FIG. 14.

As in the case explained with reference to FIG. 11, the connection-information managing unit 112 accumulates the user information extracted in S23 in the information storage region 130 (S51).

Subsequently, the connection-information managing unit 112 determines whether time and date information that elapses a predetermined period (hereinafter referred to as first date and time information as well) is present in the connection information 131 (S52). The predetermined period is, for example, three months. When the date and time information that elapses the predetermined period is present (YES in S52), the connection-information managing unit 112 erases, from the information storage region 130, information for specifying date and time when the management target terminals 2 are connected to the other management target terminals 2 (S53).

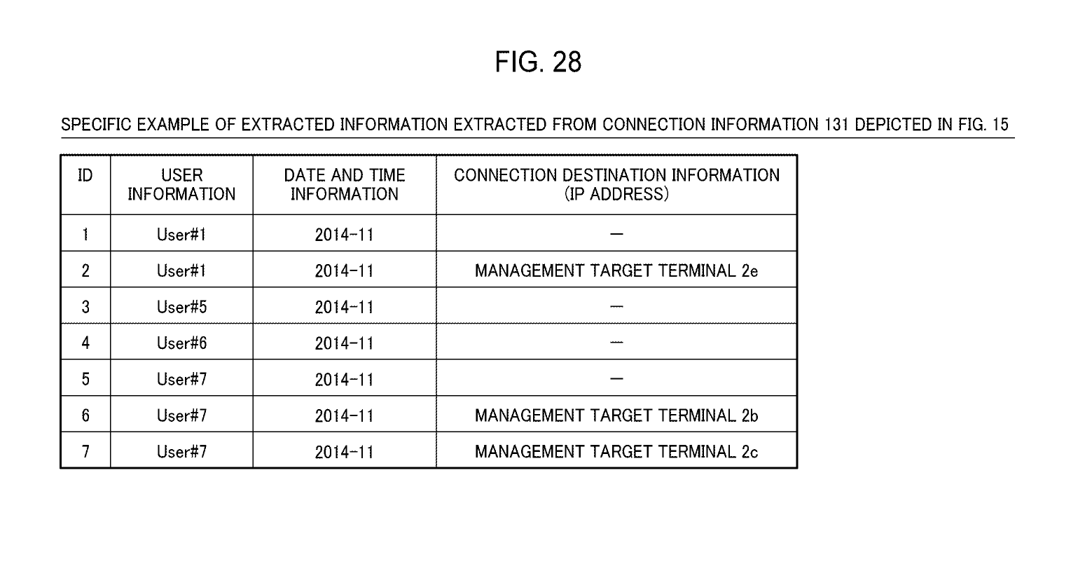

That is, among the date and time information stored in the information storage region 130, detailed information included in information that elapses the predetermined period is sometimes not used when the terminal specifying unit 113 specifies the management target terminals 2 in which the detection check of malware is performed. Therefore, the connection-information managing unit 112 may delete the information for specifying date and time, for example, concerning the date and time information that elapses the predetermined period. In this case, in the information storage region 130, as depicted in FIG. 28, only information for specifying years and months are stored are continuously stored as the date and time information. Consequently, the connection-information managing unit 112 is capable of further reducing the capacity of the storage medium 104 needed to store the connection information 131.

On the other hand, when the date and time information that elapses the predetermined time is absent (NO in S52), the connection-information managing unit 112 does not execute the processing in S53.

In this way, according to the first embodiment, the management apparatus 1 acquires the connection information 131 at the time when the management target terminals 2 are connected to the other management target terminals 2 and accumulates the connection information 131 in the storing unit 130. The management apparatus 1 specifies, according to detection of malware that performs a harmful action in the first management target terminals included in the management target terminals 2, on the basis of the connection information 131 of the first management target terminals accumulated in the storing unit 130, the monitoring target terminals 2 that need to be monitored.

Consequently, the management apparatus 1 can specify, after detection of activities of the malware, in a short period, the management target terminals 2 which is likely to be infected with the malware.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a management program that causes a computer to execute a process comprising:
acquiring connection information relating to management target terminals connected to other management target terminals and accumulating the connection information in a storage; and
specifying according to detection of malware that performs a harmful action in first management target terminals included in the management target terminals, on the basis of the connection information relating to the first management target terminals accumulated in the storage, a monitoring target terminal that needs to be monitored.

2. The non-transitory computer-readable recording medium according to claim 1, wherein
the connection information includes user information used when the management target terminals connect to the other management target terminals, and
the specifying the monitoring target terminal includes specifying the monitoring target terminal according to the user information accumulated in the storage.

3. The non-transitory computer-readable recording medium according to claim 2, wherein the connection information further includes date and time information on when the management target terminals connect to the other management target terminals and address information relating to the other management target terminals to which the management target terminals connect.

4. The non-transitory computer-readable recording medium according to claim 2, wherein the specifying the monitoring target terminal includes:
extracting, from the user information accumulated in the storage, first user information accumulated in the storage in association with management target terminals at least a predetermined ratio among the first management target terminals, and
specifying, as the monitoring target terminal, the other management target terminal to which any one of the first management target terminals connect using the first user information.

5. The non-transitory computer-readable recording medium according to claim 4, further comprising prohibiting, after the extracting the first user information, all the management target terminals from connecting to the other management target terminals using the first user information.

6. The non-transitory computer-readable recording medium according to claim 3, further comprising erasing, when first date and time information that elapses a predetermined period is present in the date and time information stored in the storage, from the storage, information for specifying date and time when any one of the management target terminals connect to the other management target terminal among information included in the first date and time information.

7. The non-transitory computer-readable recording medium according to claim 1, further comprising determining, after the specifying the monitoring target terminal, according to information concerning the malware detected from the first management target terminals, whether the malware detected from the first management target terminals is detected from the monitoring target terminal.

8. A management apparatus comprising:
a storage configured to acquire and accumulate connection information relating to management target terminals connected to other management target terminals; and
a processor configured to specify, according to detection of malware that performs a harmful action in first management target terminals included in the management target terminals, on the basis of the connection information on the first management target terminals accumulated in the storage, a monitoring target terminal that needs to be monitored.

9. The management apparatus according to claim 8, wherein
the connection information includes user information used when the management target terminals connect to the other management target terminals, and
the processor specifies the monitoring target terminal according to the user information accumulated in the storage.

10. The management apparatus according to claim 9, wherein the processor extracts, from the user information accumulated in the storage, first user information accumulated in the storage in association with management target terminals at least a predetermined ratio among the first management target terminals, and specifies, as the monitoring target terminal, the other management target terminal to which any one of the first management target terminals connect using the first user information.

11. The management apparatus according to claim 10, further comprising a processor configured to prohibit, after the extraction of the first user information, all the management target terminals from connecting to the other management target terminals using the first user information.

12. A management method comprising:
acquiring connection information relating to management target terminals connected to other management target terminals and accumulating the connection information in a storage; and
specifying, according to detection of malware that performs a harmful action in first management target terminals included in the management target terminals, on the basis of the connection information on the first management target terminals accumulated in the storage, a monitoring target terminal that needs to be monitored.

13. The management method according to claim 12, wherein
the connection information includes user information used when the management target terminals connect to the other management target terminals, and
the specifying the monitoring target terminal includes specifying the monitoring target terminal according to the user information accumulated in the storage.

14. The management method according to claim 13, wherein the specifying the terminal includes extracting, from the user information accumulated in the storage, first user information accumulated in the storage in association with management target terminals at least a predetermined ratio among the first management target terminals, and specifying, as the monitoring target terminal, the other management target terminal to which any one of the first management target terminals connect using the first user information.

15. The management method according to claim 14, further comprising prohibiting, after the extracting the first user information, all the management target terminals from connecting to the other management target terminals using the first user information.
